(19) United States
(12) Patent Application Publication
(10) Pub. No.: US 2014/0027534 A1
(43) Pub. Date: Jan. 30, 2014

(54) FUEL INJECTOR

(71) Applicants: Holger Rapp, Ditzingen (DE); Helmut Clauss, Eberdingen (DE); Wolfgang Stoecklein, Waiblingen (DE); Bernd Berghaenel, Illingen (DE); Marco Beier, Stuttgart-Feuerbach (DE); Changyi Wang, Kornwestheim (DE)

(72) Inventors: Holger Rapp, Ditzingen (DE); Helmut Clauss, Eberdingen (DE); Wolfgang Stoecklein, Waiblingen (DE); Bernd Berghaenel, Illingen (DE); Marco Beier, Stuttgart-Feuerbach (DE); Changyi Wang, Kornwestheim (DE)

(73) Assignee: ROBERT BOSCH GMBH, Stuttgart (DE)

(21) Appl. No.: 14/110,411

(22) PCT Filed: Feb. 22, 2012
(86) PCT No.: PCT/EP12/52990

§ 371 Date: Oct. 7, 2013

(30) Foreign Application Priority Data
Apr. 7, 2011 (DE) 10 2011 006 975.5
Jul. 11, 2011 (DE) 10 2011 078 947.2

(51) Int. Cl. F02M 57/00

(52) U.S. Cl. CPC F02M 57/005
USPC 239/71

(57) ABSTRACT

The invention relates to a fuel injector for a fuel injection system, in particular a common rail injection system, comprising a jet needle (2) which is guided in a stroke-movable manner in a high-pressure bore (1) of the fuel injector, wherein an injection opening (3) can be opened and closed via the stroke movement of said jet needle, and a fuel or pressure sensor (4) having at least one sensor element (5) made of a piezo electrical material for detecting characteristic pressure changes during opening and closing of the jet needle (2). According to the invention, the fuel or pressure sensor (4) is arranged in a low pressure region (6) of the fuel injector and can be loaded directly or indirectly by an axial force (F _{A}) upon opening and closing of the jet needle (2), which is proportional to the control chamber pressure in a control chamber (7). The sensor element (5) of the force or pressure sensor (4) is furthermore directly or indirectly electrically connected to a housing part (12) of the fuel injector via at least one contact surface (9) or an electrode (10) designed thereupon, in order to produce a ground connection (11).

### BACKGROUND OF THE INVENTION

The invention relates to a fuel injector for a fuel injection system, in particular a common-rail injection system, for injecting fuel into the combustion chamber of an internal combustion engine comprising a nozzle needle which is guided, such that it can perform stroke movements, in a high-pressure bore of the fuel injector and by means of the stroke movement of which at least one injection opening can be opened and closed, and comprising a force or pressure sensor with at least one sensor element formed from a piezoelectric material for detecting characteristic pressure changes during the opening and closing of the nozzle needle.

Fuel injectors of the type specified above have a nozzle needle which is guided, such that it can perform stroke movements, in a high-pressure bore and by means of the stroke movement of which at least one injection opening can be opened and closed. The opening stroke of the nozzle needle is effected by means of a release of pressure from a control chamber in which there prevails a control pressure which exerts a force acting in a closing direction on the nozzle needle. Here, the amount of fuel injected is dependent on the injection pressure and on the opening duration of the nozzle needle. Owing to wear, however, the operating characteristics of the fuel injector may vary over the service life, such that the actuation parameters must be adapted.

The laid-open specification DE 10 2007 063 103 A1 discloses a device for determining an operating characteristic of an injection valve of an injection system of an internal combustion engine, which device comprises a piezo foil sensor which can be inserted into the injection valve in order to determine the closing time of the injection valve. The abutment of the valve needle against the valve seat is advantageously determined by means of the piezo foil sensor. In this way, it is possible to detect whether a predicted time corresponds to the actual time of the abutment of the valve needle against the valve seat. If a deviation is identified, the actuation parameters of an actuation device of the injection system can be adapted correspondingly. The abutment of the valve needle against the valve seat is preferably detected by means of the action of an external force on the piezo foil sensor. The action of an external force effects a deformation and, associated therewith, a change in the charge density of the piezo material, such that a voltage generated between two electrodes arranged on the piezo material can be tapped as a signal. Since the piezo foil sensor does not require a feed voltage to generate a signal, and the signals can accordingly be tapped directly even without a charge amplifier, only a ground line and a signal line are required for tapping the signal. The signal is then preferably transmitted to an evaluation unit which is connected to the piezo foil sensor.

Taking the prior art cited above as a starting point, the invention is based on the problem of providing a fuel injector having a force or pressure sensor for determining the needle closing time, which fuel injector is of simple construction and can be produced inexpensively. In particular, the fuel injector should have a simple electrical connection of the force or pressure sensor.

### SUMMARY OF THE INVENTION

The proposed fuel injector comprises a nozzle needle which is guided, such that it can perform stroke movements, in a high-pressure bore of the fuel injector and by means of the stroke movement of which at least one injection opening can be opened and closed, and comprising a force or pressure sensor with at least one sensor element formed from a piezoelectric material for detecting characteristic pressure changes during the opening and closing of the nozzle needle. According to the invention, the force or pressure sensor is arranged in a low-pressure region of the fuel injector and, during the opening and closing of the nozzle needle, can be acted on directly or indirectly with an axial force FA which is proportional to the control chamber pressure in a control chamber. Furthermore, the sensor element of the force or pressure sensor is electrically connected directly or indirectly to a housing part of the fuel injector via at least one contact surface or via an electrode, which is formed on said contact surface, for producing a ground connection.

As a result of the arrangement of the force or pressure sensor in the low-pressure region, the load on the sensor is reduced because it is not exposed to the highly pressurized fuel. With the lower load, the demands on the sealing of the sensor arrangement with respect to the fuel-conducting region are also reduced. The additionally proposed electrical connection makes the production of a ground connection easier. The ground connection is produced automatically by the placement of the sensor element onto the ground potential, preferably a housing part or a component, which is connected to a housing part, of the fuel injector. A dedicated contacting means and/or the connection to a line is not necessary. Leading a line through the injector is thus also made substantially superfluous. If the sensor element of the force or pressure sensor bears not directly against that housing part of the injector which serves as ground potential but rather against a further component which is connected to the housing part, said further component is composed of an electrically conductive material. The connection may be realized via a contact surface of the sensor element or via an electrode formed on said contact surface, wherein the electrode preferably completely covers the contact surface. The electrode may for example be in the form of a coating. The electrode then forms the actual contact surface with respect to the ground potential. The contact surface or the electrode which serves as a contact surface is preferably formed on a face surface, which faces toward the nozzle needle, of the sensor element in order to eliminate the need for lines to be led deep into the injector.

In one preferred embodiment of the invention, it is provided that the sensor element is connected via a dedicated contacting means to a signal line. The dedicated contacting means is realized preferably in the region of an electrical insulation which electrically insulates the sensor element with respect to the surroundings. The lines leading into the injector are then preferably limited to said one signal line.

In a further preferred embodiment of the invention, the force or pressure sensor comprises at least two sensor elements which are preferably mounted one on top of the other such that contact surfaces of identical polarity face one another. The contact surfaces may in turn have electrodes which must then be electrically insulated with respect one another. The electrical insulation may however be omitted if the contact surfaces of identical polarity bear directly against one another and, in this way, fuse to form an electrode. The second sensor element is preferably of corresponding form to the first sensor element and has a contact surface facing toward the housing part, or an electrode for producing a ground connection formed on said contact surface. This makes it possible for the force or pressure sensor which comprises two sensor elements to have a ground connection on both sides, which eliminates the need for cumbersome electrical insulation of the sensor elements with respect to the surroundings. The interconnection of two sensor elements also has the advantage that the sensitivity of the sensor is increased.

In an alternative embodiment of the invention, the sensor element is of multi-layer construction and comprises at least one first and one second layer which are preferably of opposite polarity. That is to say that, in the contact region of the two layers, contact surfaces of identical polarity face one another. The multi-layer form simplifies the production of the force or pressure sensor, because there is no longer a need for a connection of the individual sensor elements. Furthermore, electrical insulation between the sensor elements is dispensed with entirely.

It is also proposed that, in embodiments with more than one sensor element and/or with a multi-layer sensor element, the dedicated contacting means for the connection to the signal line is realized in the contact region between two sensor elements or in the contact region between two layers. In this way, the line paths for the signal line can be shortened.

It is advantageously provided that, by means of an armature pin, which can perform stroke movements, of a solenoid valve which serves for the actuation of the nozzle needle, the force or pressure sensor can be acted on directly or indirectly via a force distribution plate with the axial force FA which is proportional to the control chamber pressure in the control chamber. Here, the armature pin is acted on at its lower face surface by the valve chamber pressure which, when the solenoid valve is closed, corresponds to the control chamber pressure, the nozzle needle coupled, such that the stroke movement of the nozzle needle effects a stroke movement of the armature pin. In order that the axial force exerted by the armature pin on the force or pressure sensor is introduced with substantially homogenous contact pressure into the sensor element, a force distribution plate is preferably arranged between the force or pressure sensor and the armature pin. In this way, the force or pressure sensor is, in the time period of interest, preloaded with the force pst * π* d²/4, wherein pst is the control pressure in the control chamber and d is the diameter of the armature pin. Since the control pressure exhibits a significant minimum at the time of the closing of the needle, the signal output by the force or pressure sensor will also exhibit a significant feature.

In one refinement, the force distribution plate for the introduction of the axial force F_{A} into the force or pressure sensor is preloaded axially against the force or pressure sensor by means of a preload element. In this way, an undesired change in position of the force distribution plate can be prevented.

By means of the above-described measures individually or in any desired combination, the electrical connection of the force or pressure sensor to the injector can be simplified considerably. The injector with detection of the needle closing time can thus be produced simply and inexpensively.

### BRIEF DESCRIPTION OF THE DRAWINGS

Preferred embodiments of the invention will be explained in more detail below on the basis of the drawings, in which:

FIG. 1a shows a longitudinal section through a fuel injector known from the prior art,

FIG. 1b shows a longitudinal section through the control valve of the fuel injector of FIG. 1a,

FIG. 2 shows a longitudinal section through a fuel injector according to the invention in the region of the control valve in the form of a solenoid valve,

FIGS. 3a, b show in each case a longitudinal section through a first force or pressure sensor according to the invention,

FIGS. 4a, b show in each case a longitudinal section through a second force or pressure sensor according the invention,

FIG. 4c shows a longitudinal section through a modified version of the embodiment of FIGS. 4a, b, and

FIGS. 5a, b show in each case a longitudinal section through a third force or pressure sensor according to the invention.

### DETAILED DESCRIPTION

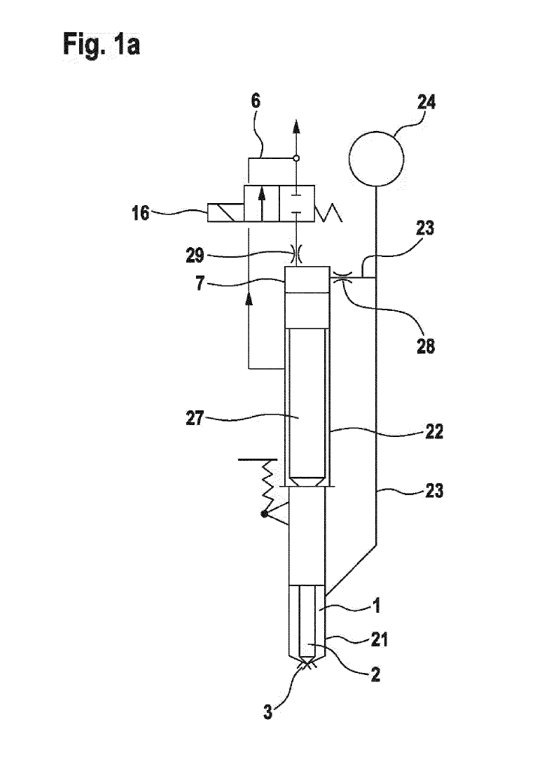

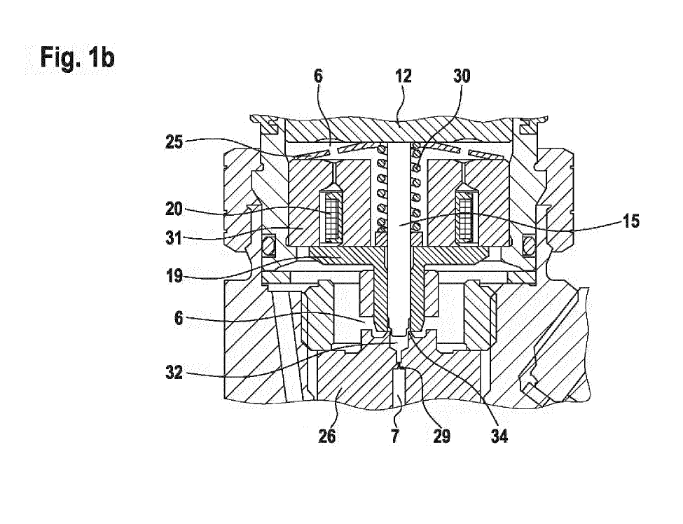

The known fuel injector illustrated in FIGS. 1a and 1b has a nozzle needle 2 which is guided, such that it can perform stroke movements, in a high-pressure bore 1 of a nozzle body 21, which nozzle needle can be acted on via a valve piston 27 with a closing force. The valve piston 27 is received, by way of its end facing away from the nozzle needle 2, in a valve piece 26, and is guided therein so as to be capable of performing stroke movements. The valve piece 26 in turn is received in an injector body 22. Within the valve piece 26, the valve piston 27 delimits a control chamber 7 in which a hydraulic pressure prevails, which hydraulic pressure exerts a force acting in a closing direction on the valve piston 27 and on the nozzle needle 2. The control chamber 7 can be connected via an inflow throttle 28 to a fuel feed line 23 and via an outflow throttle 29 to a low-pressure region 6, such that the hydraulic pressure and the valve piston movement can be varied as a function of the switching position of the solenoid valve 16. The highly pressurized fuel supplied via the feed line 23 is extracted from a high-pressure accumulator 24. Via the high-pressure bore 1 formed in the nozzle body 21, the fuel is then supplied, when the nozzle needle 2 is open, to at least one injection opening 3.

The solenoid valve 16, illustrated in more detail in figure lb, of the injector of figure la has an armature 19 which interacts with a coil 20 and which can perform stroke movements, and also an armature pin 15 which is received at least partially in said armature. The armature pin 15 is acted on at its lower face surface by a pressure prevailing in a valve chamber 32. Said pressure corresponds, in the closed state of the solenoid valve 16, to the pressure in the control chamber 7. The armature pin 15 is supported by way of its upper face surface on a housing part 12 of the injector. In the rest (deenergized) state, the armature 19 is pressed against its valve seat 34 by a compression spring 30.

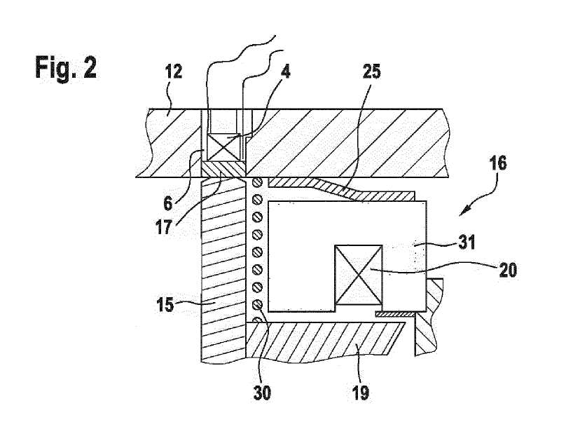

By contrast to the injector of FIGS. 1a and 1b, the fuel injector according to the invention of FIG. 2, which is illustrated partially in the region of the solenoid valve 16, has a force or pressure sensor 4 arranged in the low-pressure region 6 for the purpose of detecting the needle closing time. Furthermore, the armature pin 15 is supported not on the housing part 12 but rather indirectly on the force or pressure sensor 4 via a force distribution plate 17. When the solenoid valve 16 is closed, a change in the pressure in the control chamber 7 results in a change in the axial force F_{A} acting on the armature pin 15 and thus on the force or pressure sensor 4. Furthermore, a preload element 25 is provided for positional fixing of a magnet core 31 of the solenoid valve 16.

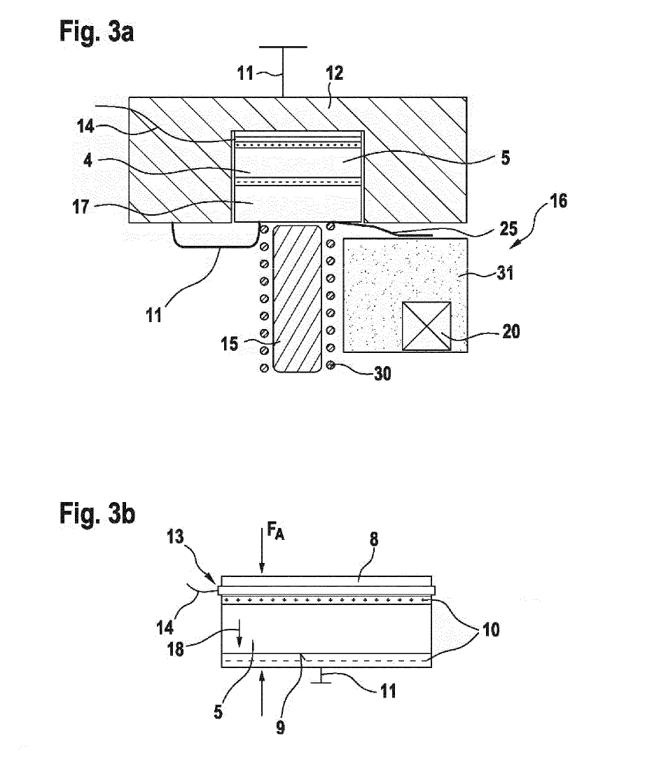

As can be seen from FIGS. 3a, b, 4a-c and 5a, b, which show preferred exemplary embodiments of a fuel injector according to the invention or of a force or pressure sensor 4 arranged therein, the force or pressure sensor 4 comprises at least one sensor element 5 formed from a piezoelectric material, which sensor element bears by way of a contact surface 9, or an electrode 10 formed on said contact surface, against the force distribution plate 17 so as to form a first ground connection 11. The force distribution plate 17 is in turn electrically connected to the surrounding housing part 12 (see FIGS. 3a, 4a and 5a). The preload element 25 for the positional fixing of the magnet core 31 or of the coil 20 and of the compression spring 30 is, in these examples, also used for axially preloading the force distribution plate 17. This is however not an imperative part of the invention. A preload may be generated by means of the compression spring 30, the preload element 25 for the magnet core 31, an additional preload element which is not illustrated, or any desired combinations of these. Alternatively, a preload of the force distribution plate 17 may also be omitted.

In the exemplary embodiment of FIGS. 3a and 3b, the force or pressure sensor 4 comprises only one sensor element 5. In the case of only one sensor element 5, the contact surface 9, or the electrode 10 formed thereon, bears directly against the force distribution plate 17 so as to produce a ground connection 11. By contrast, the contact surface situated opposite the contact surface 9, or the electrode 10 formed on the former contact surface, must not have a connection to the housing part 12 because otherwise the sensor element 5 is electrically short-circuited. To prevent this, an electrical insulator 8 is provided between the electrode 10 and the housing part 12. The connection to a signal line 14 is realized via a dedicated contacting means 13 in the region of the electrical insulator 8. The electrical connection of the force or pressure sensor 4 to the injector requires no lines aside from the signal line 14. The electrical connection is thereby simplified considerably. The electrical contacting means 13 may also serve for producing the connection to one of the two coil pins of the solenoid valve 16, such that no separate connections are required between the force or pressure sensor 4 and a control unit (not illustrated). Accordingly, all connections take place within the injector.

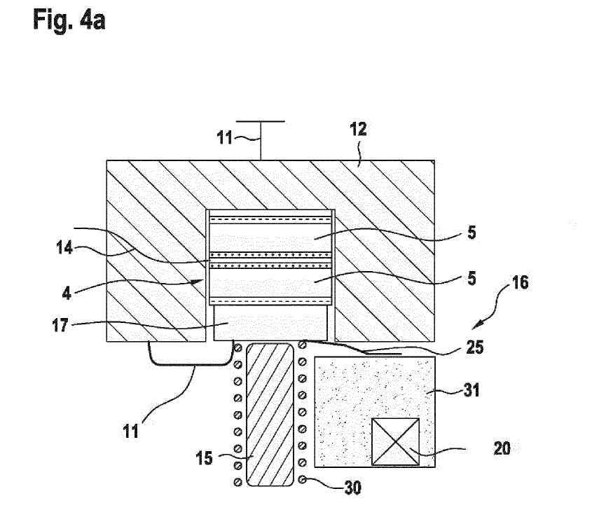

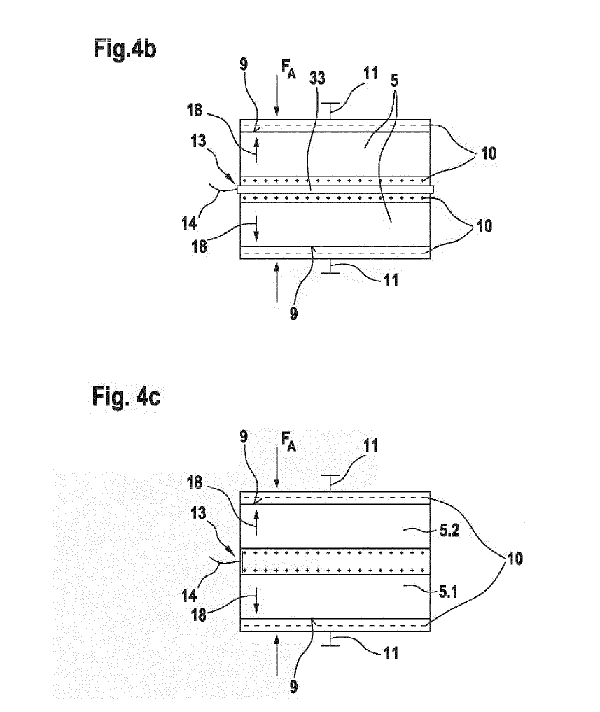

FIG. 4a and FIG. 4b show an exemplary embodiment with a force or pressure sensor 4 which comprises two sensor elements 5. The sensor elements 5 bear against one another such that the contact surfaces 9 of identical polarity, or the electrodes 10 formed on said contact surfaces, face one another. The dedicated contacting means 13 is realized in the region of a central electrode 33 which is arranged between the two electrodes 10 facing one another. The polarity 18 of the two sensor elements 5 is indicated with the aid of an arrow (see FIG. 4b).

To reduce the production outlay, it is proposed in one refinement (not illustrated) that the formation of inner electrodes 10 be omitted. The two sensor elements 5 are instead placed by way of their contact surfaces 9 onto the central electrode 33, which then performs the function of the two electrodes 10 facing one another.

Alternatively—as illustrated in FIG. 4c—the sensor element 5 may also be of multi-layer construction, wherein the first layer 5.1 replaces the first sensor element 5 and the second layer 5.2 replaces the second sensor element 5 as per the exemplary embodiment of FIG. 4b. The two electrodes 10 facing one another then fuse to form a centrally situated electrode 10 belonging integrally to the sensor element 5. The connection to a signal line 14 is realized via a dedicated contacting means 13.

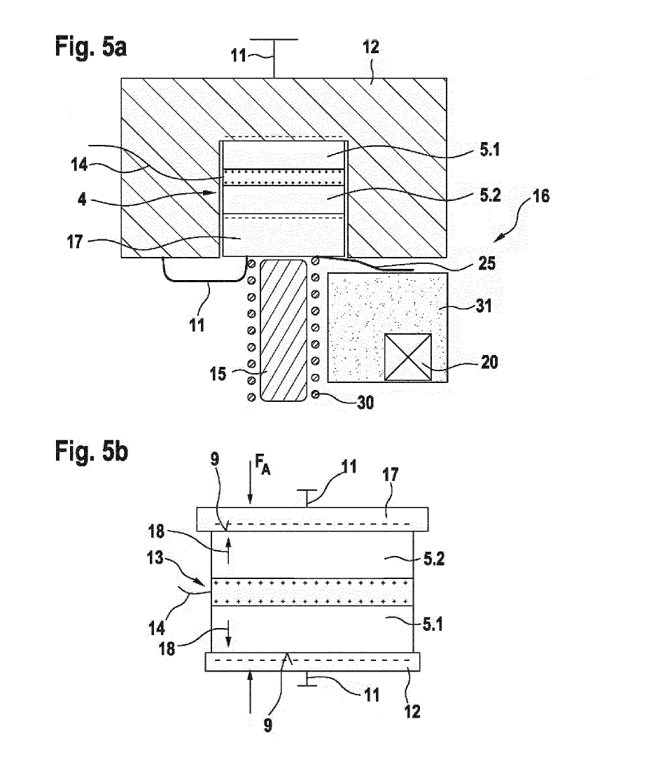

The force or pressure sensor of the exemplary embodiment of FIGS. 5a and 5b comprises a sensor element 5 which is composed of two oppositely polarized piezoelectric layers 5.1, 5.2. A first, inner electrode is formed in the contact region between the two layers 5.1, 5.2. Two further, outer electrodes are formed by means of those surfaces of the force distribution plate 17 and of the housing part 12 which bear against the contact surfaces 9, such that the separate formation of electrodes 10 on the face surfaces of the sensor element 5 can be omitted. For this purpose, the outwardly facing contact surface 9 of the first layer 5.1 bears directly against the housing part 12, and the corresponding contact surface 9 of the second layer 5.2 bears directly against the force distribution plate 17. Lines for the electrical connection of the sensor element 5 can thus be omitted. All that is required over and above this is the dedicated contacting means 13 for connecting the sensor element 5 to the signal line 14. The outlay for contacting and for insulation can thus be reduced to a minimum.

1. A fuel injector for a fuel injection system, comprising a nozzle needle (2) which is guided, such that the needle can perform stroke movements, in a high-pressure bore (1) of the fuel injector and by means of the stroke movement of which at least one injection opening (3) can be opened and closed, and comprising a force or pressure sensor (4) with at least one sensor element (5) formed from a piezoelectric material for detecting characteristic pressure changes during the opening and closing of the nozzle needle (2),
characterized in that the force or pressure sensor (4) is arranged in a low-pressure region (6) of the fuel injector and, during the opening and closing of the nozzle needle (2), can be acted on directly or indirectly with an axial force (F_{A}) which is proportional to a control chamber pressure in a control chamber (7), and in that the sensor element (5) of the force or pressure sensor (4) is electrically connected directly or indirectly to a housing part (12) of the fuel injector via at least one contact surface (9) or via an electrode (10), which is formed on said contact surface, so as to produce a ground connection (11).

2. The fuel injector as claimed in claim 1, characterized in that the sensor element (5) is connected via a dedicated contacting means (13), to a signal line (14).

3. The fuel injector as claimed in claim 1, characterized in that the force or pressure sensor (4) comprises at least two sensor elements (5).

4. The fuel injector as claimed in claim 1, characterized in that the sensor element (5) is of multi-layer construction and comprises at least one first and one second layer (5.1, 5.2).

5. The fuel injector as claimed in claim 2, characterized in that the dedicated contacting means (13) for connection to the signal line (14) is realized in a contact region between two sensor elements (5) or in a contact region between two layers (5.1, 5.2).

6. The fuel injector as claimed in claim 1, characterized in that, by means of an armature pin (15), which can perform stroke movements, of a solenoid valve (16) which serves for actuation of the nozzle needle (2), the force or pressure sensor (4) can be acted on directly or indirectly via a force distribution plate (17) with the axial force (F_{A}) which is proportional to the control chamber pressure in the control chamber (7).

7. The fuel injector as claimed in claim 6, characterized in that the force distribution plate (17) is preloaded axially against the force or pressure sensor (4) by means of a preload element (25).

8. The fuel injector as claimed in claim 1, characterized in that the sensor element (5) is connected via a dedicated contacting means (13), in a region of an electrical insulator (8), to a signal line (14).

9. The fuel injector as claimed in claim 1, characterized in that the force or pressure sensor (4) comprises at least two sensor elements (5) which are mounted one on top of the other such that contact surfaces of identical polarity (18) face one another.

10. The fuel injector as claimed in claim 1, characterized in that the sensor element (5) is of multi-layer construction and comprises at least one first and one second layer (5.1, 5.2) which are of opposite polarity.
